(19) United States
(12) Patent Application Publication
(10) Pub. No.: US 2003/0165651 A1
(43) Pub. Date: Sep. 4, 2003

(54) Self-adhesive film

(76) Inventors: Reto Sieber, Sigigen (CH); Marco Sieber, Horw (CH)

Correspondence Address: JORDAN AND HAMBURG LLP, 122 EAST 42ND STREET, SUITE 4000, NEW YORK, NY, 10168, US

(21) Appl. No.: 10/362,312

(22) PCT Filed: Mar. 14, 2001
(86) PCT No.: PCT/EP01/02867

(30) Foreign Application Priority Data
Aug. 22, 2000 (DE) 100 40 971.7
Nov. 29, 2000 (DE) 100 59 121.3

(51) Int. Cl. B32B 9/00

(52) U.S. Cl. 428/40.1; 428/138; 428/906

(57) ABSTRACT

The invention relates to a self-adhesive film for adhering a floor covering, especially a carpeting, to a floor or to a step. Said self-adhesive film comprises a supporting layer, which is coated with a pressure-sensitive adhesive coating on an upper surface facing the floor covering and on a lower surface facing the floor or the steps. According to the invention, the self-adhesive film is permeable to water vapor with an S_{d} value of 15 m or less, the supporting layer is made of a plastic film, and at least the supporting layer is perforated.

The invention relates to a pressure-sensitive adhesive film for gluing a floor covering, especially a carpeted floor, to flooring or a staircase, in accordance with the introductory portion of claim 1.

In general, pressure-sensitive adhesive tapes or films are already known, some of which are also intended for gluing a floor covering to flooring. For laying floor coverings on staircases, wet adhesives or adhesive tapes are usually used at the present time. However, enormously large adhesive residues result when the floor coverings are removed from the staircases.

Especially when a floor covering is glued to flooring with a certain residual moisture content, as is the case in new constructions with a freshly applied cement finish or a newly laid parquet floor, the problem arises that this residual moisture rises up from the flooring and, accordingly, affects -the effectiveness of the pressure-sensitive adhesives used for the gluing and accordingly also the handling properties and possibly also the residue-free detachability from pressure-sensitive adhesive tapes or films.

If floor coverings weighing more than 500 g/m² are to be used and especially glued, the additional problem arises that, under changing temperature and moisture conditions and because of the tendency to develop dimensional changes induced thereby, such floor coverings build up relatively high expansion and contraction forces. Reliable gluing therefore requires an appropriate pressure-sensitive adhesive tape or film having a high adhesive force. On the other hand, the residue-free detachability must not be impaired.

It is an object of the present invention to prepare a pressure-sensitive adhesive film for gluing floor coverings, especially for gluing a carpet on a floor or on a staircase. The pressure-sensitive adhesive film is to overcome the disadvantages of the state of the art, offer reliable gluing, be easy to handle and to remove once again and, in particular, to offer residue-free detachability, at least from floors and staircases.

Pursuant to the invention, this objective is accomplished with a pressure-sensitive adhesive film of claim 1. Preferred further developments of the invention are defined in the dependent claims.

The inventive, pressure-sensitive adhesive film is used to glue a floor covering, especially a carpeted floor, on flooring or a staircase. In particular, floor coverings weighing more than 500 g/m² can also be glued. The pressure-sensitive adhesive film has a backing, which is coated with a pressure-sensitive adhesive coating on an upper surface, facing the floor covering, and on a lower surface, facing the flooring or the staircase.

Pursuant to the invention, the pressure-sensitive adhesive film is permeable to water vapor with an s_{d} value of 15 m or less, the backing consisting of a plastic film and at least the backing being perforated. The s_{d} value gives the thickness of a layer of air, which has an equivalent water vapor diffusion, in meters. The s_{d} value of the water vapor permeability is determined by the ASTM E 398 method of Dr. Lyssy.

Due to the inventive configuration of the pressure-sensitive adhesive film, it is possible that residual moisture, rising up from the flooring, that is, the water vapor, especially in the case of freshly laid parquet or when laying floor coverings on a freshly applied cement finish, which may not have dried out completely, does not collected between the flooring and the backing of the inventive pressure-sensitive adhesive film and thus does have a negative effect on the gluing properties of the pressure-sensitive adhesive coating used. In particular, an abatement in the adhesive force, as well as a possible deterioration in the detachability can be avoided. Moreover, because of the inventive configuration of the pressure-sensitive adhesive film when gluing a floor covering, there can been no mold formation or softening of the parquet, which may have been put down, due to accumulation of water vapor

The s_{d} value preferably ranges from 0.2 m to 15 m and particularly from 0.5 m to 7 m.

Pursuant to the invention, the water-vapor permeability of the backing and of the pressure-sensitive adhesive layer arises from perforating at least the backing and/or perforations of the pressure-sensitive adhesive coating of at least one of the surfaces. In this way, water vapor permeability of the pressure-sensitive adhesive film can be achieved in a simple manner. However, the inventive perforations are not to be understood as implying that the pressure-sensitive adhesive film is merely prefabricated section-wise and that specified sections of the pressure-sensitive adhesive film can be severed from the remaining pressure-sensitive adhesive film along appropriately extending perforation holes. In general, however, if prefabrication is required and desirable, it can be carried out.

It is particularly preferred if the backing layer and/or the pressure-sensitive adhesive coating of at least over one of the surfaces are provided with perforation holes, which are distributed over the whole area. Accordingly, especially if the inventive, pressure-sensitive adhesive film is used over large surfaces, the best possible water vapor permeability is provided.

It is particularly advantageous that the perforation holes in the backing layer and in the pressure-sensitive adhesive coating of at least one of the surfaces be aligned with one another, so that direct passage of any water vapor, rising up from the flooring, is possible.

Preferably, the perforation holes are at a distance from one another of preferably less than 10 cm, the holes having a cross-sectional area of preferably less than 4 mm².

Of course, it is possible, within the scope of the invention, to combine, for example, a perforated backing having a pressure-sensitive adhesive coating, which is perforated at least at one surface, with an imperforated, permeable pressure-sensitive adhesive coating on the respective other surface. Accordingly, the backing may be provided, for example, only on the upper or the lower surface with a perforated pressure-sensitive adhesive coating and, on the respectively other surface, have an imperforated permeable pressure-sensitive adhesive coating. The perforated backing may, however, also be provided at the upper as well as at the lower surface with perforated pressure-sensitive adhesive coating, the perforation holes being aligned with one another. Preferably, the pressure-sensitive adhesive coating of at least one of the surfaces may consist of a pressure-sensitive adhesive, through which water vapor can diffuse. However, both surfaces may also have a pressure-sensitive adhesive coating, perforated or not, which consists of a pressure-sensitive adhesive, through which water vapor can diffuse.

It is advantageous if the backing, at least at its lower surface, is constructed essentially flat. Furthermore, it is advantageous if the pressure-sensitive adhesive coating at least of the lower surface is constructed essentially flat. Accordingly, at least between the perforation holes, the backing and/or the pressure-sensitive adhesive coating of the lower surface may be constructed flat. This is expressed by the term “essentially flat”.

The particularly preferred embodiment of the pressure-sensitive adhesive film is prepared in that the perforation holes are punctured from below, that is, from the side of the lower surface, facing the flooring, into the pressure-sensitive adhesive film.

In this way, it is ensured that the inventive, pressure-sensitive adhesive film, at least at the lower surface of the backing, and the pressure-sensitive adhesive coating, at least at the lower surface, are constructed essentially flat, since the burrs of the perforation holes of the backing, because of the puncturing, are directed in the upward direction away from the lower surface. Moreover, the pressure-sensitive adhesive coating at least of the lower surface essentially levels this.

The essentially flat construction of at least the lower surface of the backing and/or of the pressure-sensitive adhesive coating ensures the particularly reliable glueability of the inventive pressure-sensitive adhesive film, a two-dimensional anchoring being achieved by avoiding adhesion centers, which occur due to punctiform stronger adhesion resulting from unevennesses. This improves handling of the inventive pressure-sensitive adhesive film and contributes to the essentially residue-free detachability of the inventive pressure-sensitive adhesive film from flooring and from staircases (in event that at least the upper surface is constructed essentially flat) and/or from floor coverings (in the event that the upper surface is also constructed essentially flat).

Moreover, it is particularly preferred that, when the inventive pressure-sensitive adhesive film is detached from the flooring or the staircase or from the flooring or the staircase and/or from the floor covering, the coating of pressure-sensitive adhesive remains on the backing, so that a residue-free detachability becomes possible.

The residue-free detachability of the pressure-sensitive adhesive film from the flooring or the staircase as well as from the floor covering is of advantage particularly when, for example, a floor covering in a trade fair construction is to be used again after the exhibit stall has been taken down.

To achieve a particularly reliable gluing with, at the same time, an essentially residue-free detachability from the flooring in the case of a preferred embodiment of the inventive, pressure-sensitive adhesive film, the lower surface of the pressure-sensitive adhesive film of a pressure-sensitive adhesive coating has a lesser adhesive strength then does the upper surface.

In order to improve the handling properties of the inventive pressure-sensitive adhesive film, the latter has a removable covering film, at least at the upper surface on its pressure-sensitive adhesive coating. The covering film may consist, for example, of silicone paper or of a different suitable material.

There may also be a removable covering film additionally or only on the lower surface. This is not absolutely necessary in the event that the adhesive strength of the lower surface is less than that of the upper surface.

The covering film, detachably adherent, lies practically without gaps in contact with the corresponding upper surface.

The pressure-sensitive adhesive film may be transported in the form of rolls. For this purpose, the pressure-sensitive adhesive film is wound up into a roll. In general, the pressure-sensitive adhesive film can be unwound in the desired length from the roll. The pressure-sensitive adhesive film can be prefabricated in a particular width and also in particular lengths and/or shapes.

In order to achieve the best possible gluing results, it is particularly advantageous if the pressure-sensitive adhesive film is constructed so that it covers large areas of the flooring or the staircase, which is to be covered with the floor covering.

In this connection, it is particularly advantageous that the width of the pressure-sensitive adhesive film ranges from 80 mm to 2,000 mm, especially from 500 mm to 1,500 mm and particularly from 600 mm to 1,000 mm. For staircases, a pressure-sensitive adhesive film with a width of 240 mm and, for flooring, a pressure-sensitive adhesive film with a width of at least 350 mm are particularly preferred.

In this connection, the width is defined as the unwinding width of the roll (roll width) in the case of a pressure-sensitive adhesive film, which is rolled up into a roll.

By selecting a pressure-sensitive adhesive film of suitable width, it is possible, in particular, to achieve coverage of the flooring, which is to be glued with the pressure-sensitive adhesive film, over a large area and, accordingly, make a particularly simple and reliable gluing possible. The preferred width of 240 mm, when the pressure-sensitive adhesive film is used on staircases, is selected so that the pressure-sensitive adhesive film can cover, largely or completely, the tread as well as the riser of a step with normal dimensions in two pieces. In each case, a piece of pressure-sensitive adhesive film, cut to a suitable size, can be applied on the tread and on the riser of the step, their respective edges meeting or overlapping slightly in the region of the edge of the step and, accordingly, forming a gap-free adhesive surface. Extensive or complete coverage of the surface by the pressure-sensitive adhesive film can also be achieved if a pressure-sensitive adhesive film of lesser width is selected. In such a case, however, more than one piece of pressure-sensitive adhesive film, cut to a suitable size, is required. More than two pieces can then be cut to suitable dimensions and also, for example, placed around the edge of the step.

Especially in the private sector, there may furthermore be a need for floor coverings, which are not fixed over their whole area. For this purpose, the inventive pressure-sensitive adhesive film can also be provided in a width of 80 mm to 500 mm. In the case of an appropriate configuration, floor coverings are fixed essentially only in their edge region with an inventive pressure-sensitive adhesive film of appropriate width, or an appropriate pressure-sensitive adhesive film is placed below the seam region in the case of a transition between two floor covering pieces. In this embodiment, the inventive pressure-sensitive adhesive film can be handled like a conventional carpet tape.

The inventive, pressure-sensitive adhesive film is used preferably in the following way for gluing a floor covering.

As far as possible, the whole of the flooring is covered, without gaps, with the pressure-sensitive adhesive film. In so doing, the lower surface, which preferably has the lesser adhesive strength, is directed in the direction of the flooring. The upper surface preferably is covered with the covering film. The floor covering is then laid down provisionally and, optionally, cut to size. Subsequently, a portion of the floor covering is folded back and the covering film on this part of the pressure-sensitive adhesive film is removed. The folded-backed part of the floor covering is folded once again onto the upper surface, which preferably has the greater adhesive strength, and optionally pressed down. The procedure with the remaining parts of the floor covering is the same, until the whole of the floor covering is glued to the flooring.

For the preferred, residue-free detachment of the floor covering from the flooring, the floor covering need only be pulled upward from the flooring. In so doing, the pressure-sensitive adhesive film separates from the flooring and, preferably, continues to adhere to the floor covering. At the same time, the pressure-sensitive adhesive coating of the lower surface remains at the backing. Additionally, it is also possible that the inventive, pressure-sensitive adhesive film is configured so that it can be detached from the floor covering and that the pressure-sensitive adhesive coating of the upper surface remains at the backing. Accordingly, when the floor covering is used, for example, in trade fairs, it can be used again without the ability to handle it being limited by possible adhesive residues, which may be at its underside.

The material of the plastic backing film may, in particular, be polypropylene or polyethylene film. The backing may also consist of a polyamide film. However, any other suitable material, such as rubber, latex or the like, is also conceivable.

In order to provide good handling of the inventive, pressure-sensitive adhesive film, particularly also when it is perforated, the backing layer has a thickness ranging from 10 to 100 μm, preferably from 25 to 75 μm and particularly from 50 to 70 μm.

As pressure-sensitive adhesives, an acrylate dispersion, enriched, for example, with resins and with the UV and aging protection contained therein, has proven its value. However, any other suitable pressure-sensitive adhesive dispersion adhesive, through which water vapor can diffuse, can also be used. Preferably, the pressure-sensitive adhesive coating extends over the whole surface; it may, however, also be applied in sections.

Different pressure-sensitive adhesives, such as those with the different adhesive forces, or the same pressure-sensitive adhesive can be used on each of the two surfaces.

1. The pressure-sensitive adhesive film for gluing a floor covering, especially carpeting, on flooring or a staircase, with a backing, which is coated with a pressure-sensitive adhesive coating on the upper surface, facing the floor covering, and on a lower surface, facing the flooring or the staircase, wherein the pressure-sensitive adhesive film is permeable to water vapor with an s_{d} value of 15 m or less, the backing consisting of plastic film and at least the backing being perforated

2. The pressure-sensitive adhesive film of claim 1, wherein the pressure-sensitive adhesive coating of at least one of the surfaces is perforated.

3. The pressure-sensitive adhesive film of claims 1 or 2, wherein at least the backing and optionally also the pressure-sensitive adhesive coating of at least one of the surfaces is provided with perforation holes distributed over the whole surface.

4. The pressure-sensitive adhesive film of claim 3, wherein the perforation holes in the backing and the pressure-sensitive adhesive coating of at least one of the surfaces are disposed aligned with one another.

5. The pressure-sensitive adhesive film of one of the claims 3 or 4, wherein the perforation holes are provided at a distance preferably of less than 10 cm from one another, the holes having a cross-sectional area preferably of less than 4 mm².

6. The pressure-sensitive adhesive film of one of the claims 1 to 5, wherein the lower surface of the backing is constructed essentially flat.

7. The pressure-sensitive adhesive film of one of the claims 1 to 6, wherein at least the lower surface of the pressure-sensitive adhesive coating is constructed essentially flat.

8. The pressure-sensitive adhesive film of one of the claims 1 to 7, wherein at least one of the surfaces of the pressure-sensitive adhesive coating consists of a pressure-sensitive adhesive, through which water vapor can diffuse.

9. The pressure-sensitive adhesive film of one of the claims 1 to 8, wherein, during detachment from the flooring or the staircase or from the flooring or the staircase and from the floor covering, the pressure-sensitive adhesive coating remains at the backing.

10. The pressure-sensitive adhesive film of one of the claims 1 to 9, wherein the adhesive strength of the pressure-sensitive adhesive coating at the lower surface is less than that of the pressure-sensitive adhesive coating at the upper surface.

11. The pressure-sensitive adhesive film of one of the claims 1 to 10, wherein a removable covering film is present on at least the upper surface.

12. The pressure-sensitive adhesive film of one of the claims 1 to 11, wherein said film is constructed to cover the flooring or staircase, on which the floor covering is laid, over a large surface.

13. The pressure-sensitive adhesive film of one of the claims 1 to 12, wherein the width of the film ranges from 80 mm to 2,000 mm, particularly from 500 mm to 1,500 mm and especially from 600 mm to 1,000 mm, the width being, in particular, 240 mm for use on staircases and at least 350 mm for use on flooring.

14. The pressure-sensitive adhesive film of one of the claims 1 to 11, wherein the width of said film ranges from 80 mm to 500 mm.

15. The pressure-sensitive adhesive film of one of the claims 1 to 14, wherein the backing has a thickness ranging from 10 to 100 μm, particularly from 25 to 75 μm and especially from 50 to 70 μm.

16. The pressure-sensitive adhesive film of one of the claims 1 to 15, wherein the s_{d} value ranges from 0.2 m to 15 m and especially from 0.5 m to 7 m.

17. The pressure-sensitive adhesive film of one of the claims 1 to 16, wherein the pressure-sensitive adhesive film is wound up into a roll.
